(19) United States
(12) Patent Application Publication
(10) Pub. No.: US 2019/0355006 A1
(43) Pub. Date: Nov. 21, 2019

(54) SALES PROMOTION SUPPORT APPARATUS, SALES PROMOTION SUPPORT SYSTEM, AND METHOD THEREFOR

(71) Applicant: TOSHIBA TEC KABUSHIKI KAISHA, Tokyo (JP)

(72) Inventor: Hiroshi Nishikawa, Izunokuni Shizuoka (JP)

(21) Appl. No.: 16/412,572

(22) Filed: May 15, 2019

(30) Foreign Application Priority Data
May 18, 2018 (JP) 2018-096275

(51) Int. Cl. G06Q 30/02

(52) U.S. Cl. CPC G06Q 30/0226; G06K 7/10297; G06Q 30/0238

(57) ABSTRACT

According to one embodiment, a service provision determination unit (determination means) determines whether or not to provide a predetermined service based upon code information, which is acquired by an individual commodity code acquisition unit (acquisition means), attached to a commodity purchased by a customer and uniquely specifying the commodity, and a sales history including the code information and a sales date and time stored by a sales history storage unit (storage means). Further, a service provision instruction unit (provision means) provides the predetermined service to the customer based upon a determination result of the service provision determination unit.

### CROSS-REFERENCE TO RELATED APPLICATIONS

This application is based upon and claims the benefit of priority from Japanese Patent Application No. 2018-096275, filed in May 18, 2018, the entire contents of which are incorporated herein by reference.

### FIELD

Embodiments described herein relate generally to a sales promotion support apparatus, a sales promotion support system, and a method therefor.

### BACKGROUND

There is a system for achieving sales promotion by giving a point as a benefit when purchasing a commodity at a store and providing a benefit according to accumulated points (for example, JP-A-2017-188166).

However, in the system disclosed in JP-A-2017-188166, only a customer who is registered in advance and given a customer ID (an identification number) can receive the benefit. That is, it is necessary that a customer performs membership registration, and it is necessary to specify a customer who purchases a commodity and to manage a customer ID of the customer and the purchased commodity in association with each other. Therefore, a system capable of achieving the sales promotion with a simpler configuration is desired.

### DESCRIPTION OF THE DRAWINGS

FIG. 1 is a system configuration diagram illustrating one example of a system configuration of a sales promotion support system according to an embodiment;

FIG. 2 is a hardware block diagram illustrating one example of a hardware configuration of a server apparatus;

FIG. 3 is a hardware block diagram illustrating one example of a hardware configuration of a POS terminal;

FIG. 4 is a functional block diagram illustrating one example of a functional configuration of the server apparatus;

FIG. 5 is a diagram illustrating a configuration of code information attached to a commodity;

FIG. 6 is a sequence diagram illustrating one example of an operation of the sales promotion support system according to the embodiment;

FIG. 7 is a flowchart illustrating one example of a flow of processing performed when the promotion support system registers information on a commodity sold to a customer; and

FIG. 8 is a flowchart illustrating one example of a flow of processing in which the sales promotion support system reads a tag presented by a customer and then determines whether or not there exists a service to be provided.

### DETAILED DESCRIPTION

An exemplary embodiment provides a sales promotion support apparatus, a sales promotion support system, a method therefor capable of providing a service even to a customer who does not have a customer ID.

In general, according to one embodiment, a sales promotion support apparatus includes acquisition means, storage means, determination means, and provision means. The acquisition means acquires code information that is attached to a commodity sold to a customer and uniquely specifies the commodity. The storage means stores a sales history including the code information acquired by the acquisition means and a sales date and time of the commodity. The determination means determines whether or not to provide a predetermined service based upon code information attached to a commodity purchased by a customer and a storage content of the storage means. The provision means provides the predetermined service based upon a determination result of the determination means.

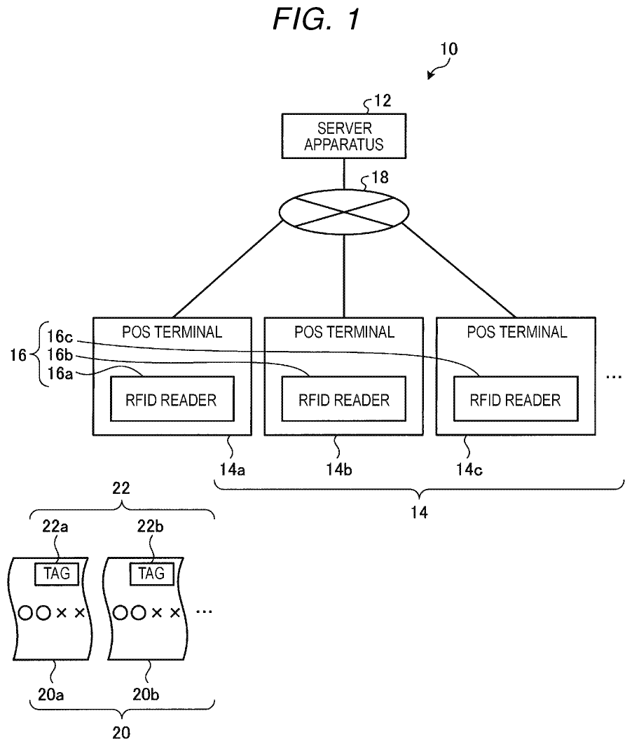

Hereinafter, a sales promotion support system according to an embodiment will be described with reference to the accompanying drawings. Further, the embodiment described hereinafter is one embodiment of a sales promotion support apparatus, a sales promotion support system, and a method therefor, and does not limit the configuration, specification, and the like thereof. FIG. 1 is a system block diagram illustrating one example of a system configuration of a sales promotion support system 10. In the sales promotion support system 10 according to the embodiment, a customer can receive a predetermined service by presenting a tag attached to a purchased commodity to a store.

The sales promotion support system 10 includes a server apparatus 12, a POS terminal 14 (14a, 14b, 14c, . . . ) respectively provided in stores such as retail stores, and a LAN 18 that connects the server apparatus 12 and the POS terminal 14.

The POS terminal 14 (14a, 14b, 14c, . . . ) is respectively provided in a plurality of stores such as retail stores, and the like, and performs commodity registration processing for registering commodity information of a commodity purchased by a customer, and settlement processing for performing settlement based upon a result of the commodity registration processing.

Further, the POS terminal 14 reads a tag 22 (22a, 22b, . . . ) attached to a commodity 20 (20a, 20b, . . . ), and acquires an individual commodity code including a serial number which is registered in the tag 22 and is capable of uniquely specifying the commodity 20, for example, an EPC (Electronic Product Code). Further, the tag 22 in the embodiment is an RFID (Radio Frequency Identification) tag that causes registered information to be read by applying a radio wave from a short distance.

The server apparatus 12 receives a sales history of the commodity 20 from the POS terminal 14, and then accumulates and stores the sales history thereof. The server apparatus 12 is, for example, an EPCIS (EPC Information Service) server, and the like capable of managing the sales history of the commodity 20 based upon the individual commodity code.

Further, the server apparatus 12 statistically analyzes a purchase frequency, and the like of the commodity 20 based upon the accumulated and stored sales history of the commodity 20. Further, the server apparatus 12 is one example of the sales promotion support apparatus.

Hardware Configuration of Server Apparatus

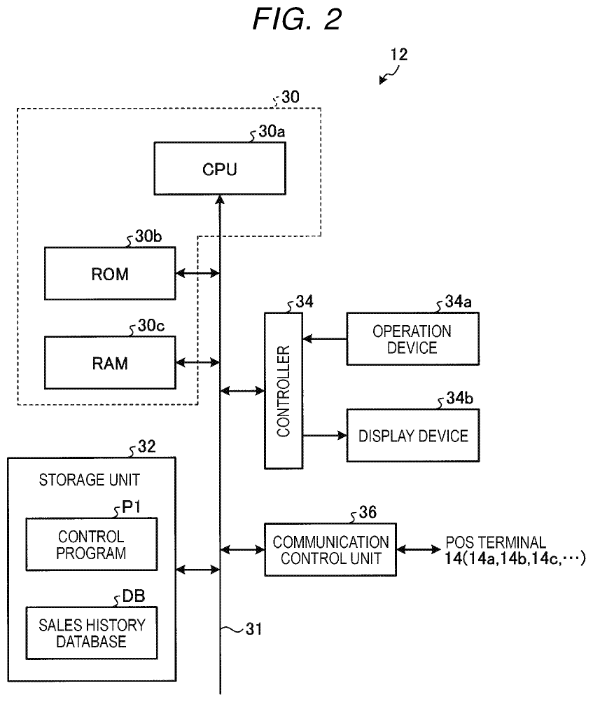

Next, a hardware configuration of the server apparatus 12 will be described with reference to FIG. 2. FIG. 2 is a hardware block diagram illustrating one example of the hardware configuration of the server apparatus 12. As illustrated in FIG. 2, the server apparatus 12 includes a control unit 30, a storage unit 32, a controller 34, and a communication control unit 36.

The control unit 30 has a general computer configuration including a CPU (Central Processing Unit) 30a, a ROM (Read Only Memory) 30b, and a RAM (Random Access Memory) 30c. The CPU 30a reads out various programs, data files, and the like stored in the ROM 30b and the storage unit 32 which will be described later, and then develops the programs and the data files in the RAM 30c. The CPU 30a operates according to the various programs, the data files, and the like developed in the RAM 30c, thereby managing the whole control of the server apparatus 12.

The control unit 30 is respectively connected to the storage unit 32, the controller 34, and the communication control unit 36 via an internal bus 31.

The storage unit 32 holds storage information even though a power source is turned off. Specifically, the storage unit 32 is an HDD (Hard Disk Drive). Further, a non-volatile memory such as a flash memory may be provided instead of the HDD. The storage unit 32 stores a program, and the like including a control program P1. The control program P1 is a program for exhibiting a function provided in the server apparatus 12. Further, the control program P1 may be provided by being incorporated in the ROM 30b in advance. Further, the control program P1 may be configured to be a file of a type capable of being installed in the control unit 30 or of a type capable of being executed therein, and to be provided by being recorded on a recording medium capable of being read by a computer such as a CD-ROM, a flexible disk (FD), a CD-R, a DVD (Digital Versatile Disc), and the like. Further, the control program P1 may be configured to be stored on a computer connected to a network such as the Internet, and the like, and to be provided by being downloaded via the network. Further, the control program P1 may be configured to be provided or distributed via the network such as the Internet, and the like.

The storage unit 32 further stores a sales history database DB.

The sales history database DB is a database that accumulates and stores the sales history of the commodity 20. The sales history database DB accumulates and stores information including a commodity code of the commodity 20, an individual commodity code uniquely specifying the commodity 20, and a sales date and time of the commodity 20. Further, the commodity code and the individual commodity code will be described in detail later.

The controller 34 connects the control unit 30 to an operation device 34a and a display device 34b. The operation device 34a is, for example, a keyboard or a touch panel. The operation device 34a detects operation information of an operator and then transmits the detected operation information to the control unit 30. The display device 34b is, for example, a liquid crystal display. The display device 34b displays a display screen based upon an instruction of the control unit 30.

The communication control unit 36 performs communication with the POS terminal 14, thereby exchanging various information. Further, the server apparatus 12 and the POS terminal 14 are connected to each other by, for example, a wired LAN (Local Area Network) or a wireless LAN, and the like.

Hardware Configuration of POS terminal

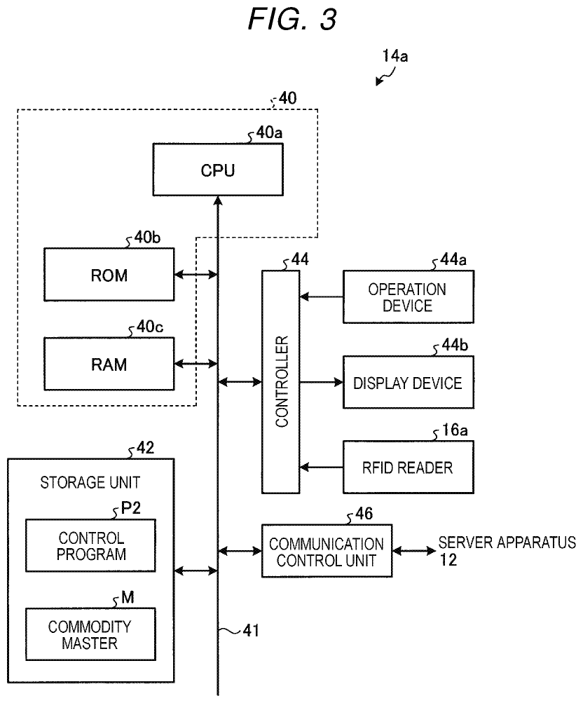

Next, a hardware configuration of the POS terminal 14a will be described with reference to FIG. 3. FIG. 3 is a hardware block diagram illustrating one example of the hardware configuration of the POS terminal 14a. Further, since the POS terminals 14a, 14b, . . . include the same hardware configuration, the POS terminal 14a will be described here. As illustrated in FIG. 3, the POS terminal 14a includes a control unit 40, a storage unit 42, a controller 44, and a communication control unit 46.

The control unit 40 has a general computer configuration including a CPU 40a, a ROM 40b, and a RAM 40c. The CPU 40a reads out various programs, data files, and the like stored in the ROM 40b and the storage unit 42 which will be described later, and then develops the programs and the data files in the RAM 40c. The CPU 40a operates according to the various programs, the data files, and the like developed in the RAM 40c, thereby managing the whole control of the POS terminal 14a.

The control unit 40 is respectively connected to the storage unit 42, the controller 44, and the communication control unit 46 via an internal bus 41.

The storage unit 42 holds storage information even though a power source is turned off. Specifically, the storage unit 42 is an HDD (Hard Disk Drive). Further, a non-volatile memory such as a flash memory may be provided instead of the HDD. The storage unit 42 stores a program, and the like including a control program P2. The control program P2 is a program for exhibiting a function provided in the POS terminal 14a.

The storage unit 42 further stores a commodity master M. The commodity master M is a master file in which commodity information such as a name, a unit price, and the like of the commodity 20 is registered in association with a commodity code.

The controller 44 connects the control unit 40 to an operation device 44a, a display device 44b, and an RFID reader 16a. The operation device 44a is, for example, a keyboard or a touch panel. The operation device 44a detects operation information of an operator and then transmits the detected operation information to the control unit 40. The display device 44b is, for example, a liquid crystal display. The display device 44b displays a display screen based upon an instruction of the control unit 40.

The RFID (Radio Frequency Identification) reader 16a applies a radio wave to the tag 22 attached to the commodity 20, thereby reading the code information registered in the tag 22. Further, as illustrated in FIG. 1, the respective RFID readers 16a, 16b, 16c, . . . are connected to the respective POS terminals 14a, 14b, 14c, . . . .

The communication control unit 46 performs communication with the server apparatus 12, thereby exchanging various information.

Further, in the embodiment, the tag 22 is an RFID tag, and the registered information is configured to be read by the RFID reader 16, however, this configuration may be realized by another form. For example, the tag 22 may be formed of a two-dimensional code and may be read by using a two-dimensional code reader instead of the RFID reader 16.

Functional Configuration of Server Apparatus

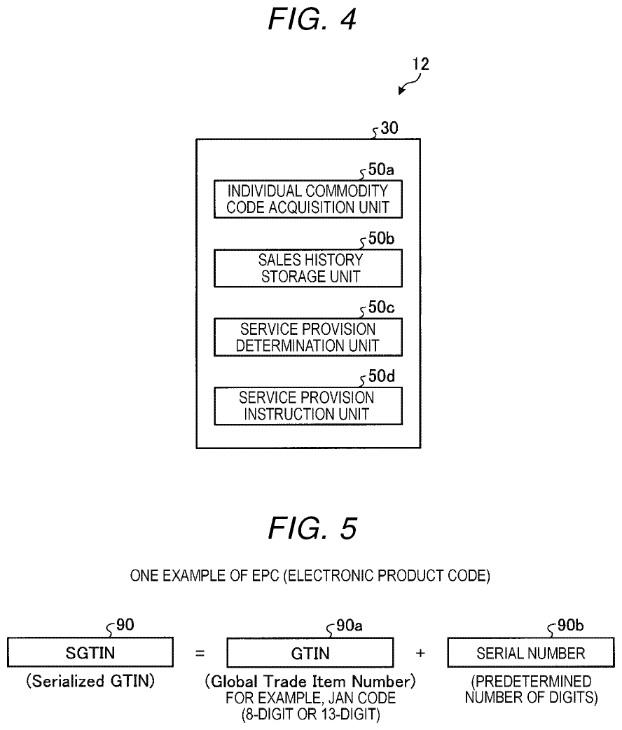

Next, a functional configuration of the sever apparatus 12 will be described with reference to FIG. 4. FIG. 4 is a functional block diagram illustrating one example of the functional configuration of the server apparatus 12.

As illustrated in FIG. 4, the control program P1 executed by the server apparatus 12 has a module configuration including an individual commodity code acquisition unit 50a, a sales history storage unit 50b, a service provision determination unit 50c, and a service provision instruction unit 50d. As actual hardware, the CPU 30a reads out the control program P1 from the storage unit 32 and executes the control program P1 by developing the control program P1 on the RAM 30c, whereby each unit illustrated in FIG. 4 is generated in the control unit 30.

The individual commodity code acquisition unit 50a acquires code information attached to the commodity 20 sold to the customer and uniquely specifying the commodity 20. Further, the individual commodity code acquisition unit 50a is one example of an acquisition unit.

The sales history storage unit 50b stores a sales history including the code information acquired by the individual commodity code acquisition unit 50a and the sales date and time of the commodity 20. Further, the sales history storage unit 50b is one example of a storage unit.

The sales history storage unit 50b may store the sales histories in a plurality of stores set in advance, for example, affiliated stores, related stores, and the like in association with each other. Accordingly, the customer can receive a predetermined service by adding up the purchase results in the plurality of stores set in advance.

The service provision determination unit 50c determines whether or not to provide the predetermined service based upon the code information attached to the commodity 20 purchased by the customer and a storage content of the sales history storage unit 50b. Further, the service provision determination unit 50c is one example of a determination unit.

More specifically, the service provision determination unit 50c stores various conditions for providing a service. For example, whether or not a predetermined commodity 20 is purchased at a frequency exceeding a predetermined threshold value within a predetermined period, or whether or not there exists a simultaneously purchased commodity purchased simultaneously with a specific commodity 20 at a frequency exceeding a predetermined threshold value, and the like are stored as conditions for providing the service.

The service provision instruction unit 50d provides the predetermined service based upon a determination result of the service provision determination unit 50c. Further, the service provision instruction unit 50d is one example of a provision unit.

Specifically, when the predetermined commodity 20 is purchased at the frequency exceeding the predetermined threshold value within the predetermined period, the service provision instruction unit 50d instructs the POS terminal 14a to provide a service such as distributing a discount coupon ticket, providing one piece of the predetermined commodity 20 free of charge, and the like.

Further, when there exists the simultaneously purchased commodity purchased simultaneously with the specific commodity 20 at the frequency exceeding the predetermined threshold value, the service provision instruction unit 50d instructs the POS terminal 14a to provide a service such as distributing a discount coupon ticket for the simultaneously purchased commodity, and the like.

Code Information

Next, the code information attached to the commodity 20 will be described with reference to FIG. 5. FIG. 5 is a diagram illustrating a configuration of the code information attached to the commodity 20.

In the embodiment, code information referred to as an EPC (Electronic Product Code) is imparted to the tag 22 (22a, 22b, . . . ) attached to the commodity 20 (20a, 20b, . . . ). More specifically, an SGTIN (Serialized GTIN) 90 that uniquely specifies the commodity 20 is attached to the tag 22. Further, the SGTIN 90 is one example of the code information.

The SGTIN 90 includes a GTIN (Global Trade Item Number) 90a and a serial number 90b. The GTIN 90a is an identification number of the commodity 20, a so-called commodity code. The GTIN 90a is, for example, an 8-digit or 13-digit JAN (Japanese Article Number) code. The serial number 90b includes a predetermined number of digits, and is a number uniquely specifying the commodity 20 itself, that is, an individual commodity code. By imparting the SGTIN 90, it is possible to identify each of the commodities 20 even in the case of the same type of the commodity 20.

Operation Example of Sales Promotion Support System

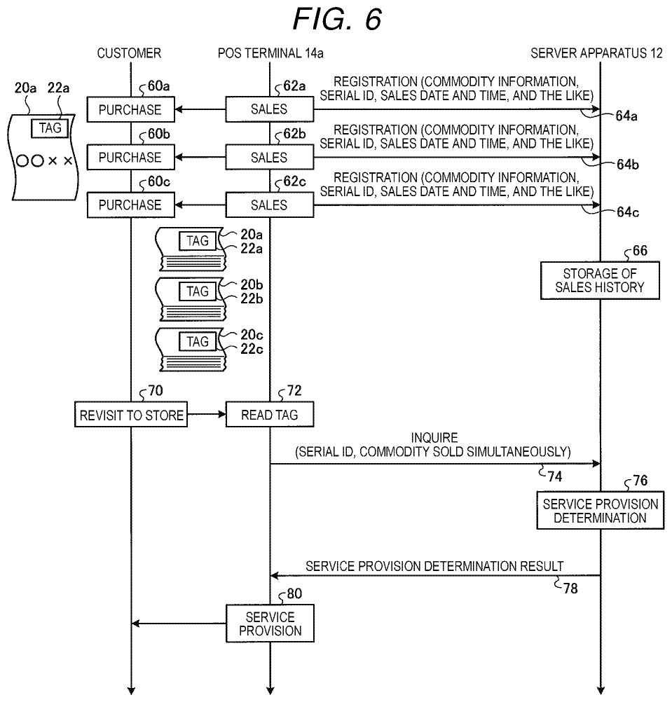

Next, an operation example of the sales promotion support system 10 according to the embodiment will be described with reference to FIG. 6. FIG. 6 is a sequence diagram illustrating one example of the operation of the sales promotion support system 10 according to the embodiment.

A customer purchases the same commodities 20a, 20b, and 20c at a store. FIG. 6 indicates that the customer purchased the commodities 20a, 20b, and 20c in three divided times (events 60a, 60b, and 60c).

When the customer purchases the commodities 20a, 20b, and 20c, the POS terminal 14a performs commodity registration processing and settlement processing each time (events 62a, 62b, and 62c). The commodity registration processing is processing for registering the commodity information, the serial numbers, the sales date and time, and the like of the sold commodities 20a, 20b, and 20c. The settlement processing is processing for settling the total amount of the registered commodities.

The POS terminal 14a transmits various types of information registered by the commodity registration processing to the server apparatus 12 (arcs 64a, 64b, and 64c).

The server apparatus 12 stores the various information received from the POS terminal 14a in the sales history database DB (event 66).

Later, the customer visits the store with empty bags of the commodities 20a, 20b, and 20c (event 70). Further, the customer may bring only the tags 22a, 22b, and 22c by removing the tags 22a, 22b, and 22c from the empty bags. Then, the POS terminal 14a is caused to read the tags 22a, 22b, and 22c attached to the commodities 20a, 20b, and 20c (event 72).

Based upon the code information registered in the read tags 22a, 22b, and 22c, the POS terminal 14a inquires the sales history of the commodity 20 including the read serial number, information on the commodity sold simultaneously with the commodity 20, and the like of the sales history database DB provided in the server apparatus 12 (arc 74).

The server apparatus 12 determines whether or not there exists a service to be provided to the customer based upon the information received from the POS terminal 14a and the sales history stored in the sales history database DB (event 76).

Next, the server apparatus 12 transmits a service provision determination result to the POS terminal 14a (arc 78).

The POS terminal 14a provides a service such as issuing a coupon, and the like to the customer (event 80).

Flow of Processing performed when the sales promotion support system registers information on a sold commodity

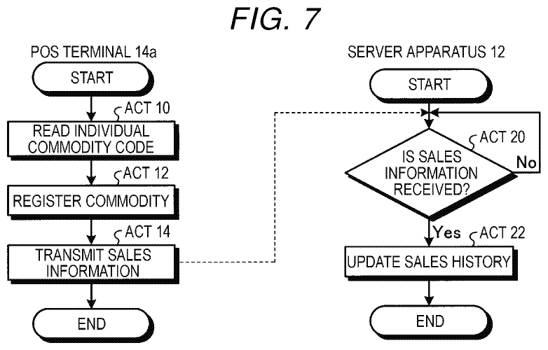

Next, a flow of processing performed when the sales promotion support system 10 registers information on a sold commodity will be described with reference to FIG. 7. FIG. 7 is a flowchart illustrating one example of a flow of processing performed when the sales promotion support system 10 according to the embodiment registers information on a commodity sold to a customer.

First, a flow of processing performed by the POS terminal 14a will be described. The RFID reader 16a reads the individual commodity code from the tag 22 attached to the commodity 20 purchased by the customer (ACT 10).

Thereafter, the control unit 40 of the POS terminal 14a performs commodity registration processing for registering commodity information including the individual commodity code read in ACT 10 (ACT 12).

Next, the control unit 40 of the POS terminal 14a transmits sales information to the server apparatus 12 (ACT 14). Thereafter, the POS terminal 14a terminates the commodity registration processing, however, since the customer actually purchases a plurality of commodities 20, the commodity registration processing of the next commodity 20 is repeated.

Next, a flow of processing performed by the server apparatus 12 will be described. First, the individual commodity code acquisition unit 50a of the server apparatus 12 determines whether or not the sales information is received from the POS terminal 14a (ACT 20). When it is determined that the sales information is received from the POS terminal 14a (ACT 20: YES), the processing proceeds to ACT 22. On the other hand, when it is not determined that the sales information is received from the POS terminal 14a (ACT 20: NO), the determination of ACT 20 is repeated.

Next, the sales history storage unit 50b updates the content of the sales history database DB by storing the sales information received from the POS terminal 14a in the sales history database DB (ACT 22). Thereafter, the server apparatus 12 terminates the processing.

Flow of Processing performed when the sales promotion support system provides a predetermined service based upon the sales history

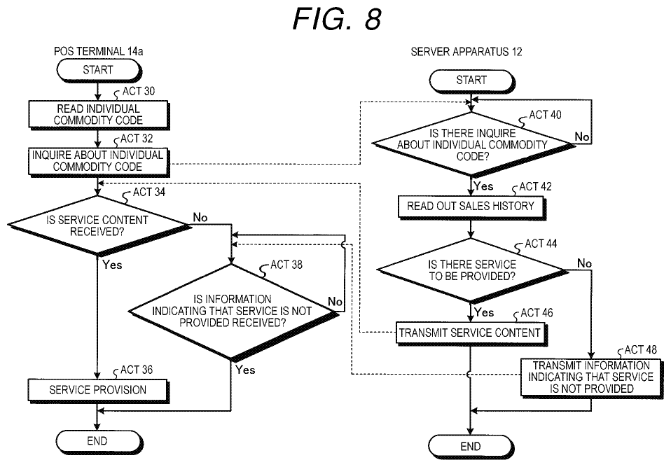

Next, a flow of processing performed when the sales promotion support system 10 provides a predetermined service based upon the sales history will be described with reference to FIG. 8. FIG. 8 is a flowchart illustrating one example of a flow of processing in which the sales promotion support system 10 according to the embodiment reads the tag 22 presented by a customer and then determines whether or not there exists a service to be provided.

First, a flow of processing performed by the POS terminal 14a will be described. The RFID reader 16a provided in the POS terminal 14a reads the individual commodity code from the tag 22 attached to the empty bag, and the like of the commodity 20 brought by a customer (ACT 30).

Next, the POS terminal 14a inquires the sales history of the individual commodity code of the commodity 20 read in ACT 30 of the server apparatus 12 (ACT 32). Further, when the customer brings a plurality of tags 22 attached to the commodities 20, ACTS 30 and 32 are repeated a plurality of times.

The POS terminal 14a determines whether a service content to be provided to the customer is received from the server apparatus 12 (ACT 34). When it is determined that the service content to be provided to the customer is received therefrom (ACT 34: YES), the processing proceeds to ACT 36. On the other hand, when it is not determined that the service content to be provided to the customer is received (ACT 34: NO), the processing proceeds to ACT 38.

When YES is determined in ACT 34, the service is provided to the customer in ACT 36. Specifically, the service is presentation of a coupon, cash back, and the like. Thereafter, the POS terminal 14a terminates the processing.

On the other hand, when NO is determined in ACT 34, the POS terminal 14a determines whether or not information indicating that the service is not provided is received from the server apparatus 12 in ACT 38. When it is determined that the information indicating that the service is not provided is received therefrom (ACT 38: YES), the POS terminal 14a terminates the processing. On the other hand, when it is not determined that the information indicating that the service is not provided is received (ACT 38: NO), the POS terminal 14a repeats the determination of ACT 38.

Next, a flow of processing performed by the server apparatus 12 will be described. The individual commodity code acquisition unit 50a determines whether or not there exists an inquiry about the sales history of the individual commodity code from the POS terminal 14a (ACT 40). When it is determined that there exists the inquiry about the sales history of the individual commodity code (ACT 40: YES), the processing proceeds to ACT 42. On the other hand, when it is not determined that there exists the inquiry about the sales history of the individual commodity code (ACT 40: NO), the determination of ACT 40 is repeated.

The service provision determination unit 50c reads out the sales history of the commodity including the inquired individual commodity code from the sales history storage unit 50b (ACT 42).

The service provision determination unit 50c determines whether or not there exists the service to be provided based upon the read sales history (ACT 44). When it is determined that there exists the service to be provided (ACT 44: YES), the processing proceeds to ACT 46. On the other hand, when it is not determined that there exists the service to be provided (ACT 44: NO), the processing proceeds to ACT 48.

When YES is determined in ACT 44, the service provision instruction unit 50d transmits a content of the service to be provided to the POS terminal 14a in ACT 46. Thereafter, the server apparatus 12 terminates the processing.

On the other hand, when NO is determined in ACT 44, in ACT 48, the service provision instruction unit 50d transmits the information indicating that there is no service to be provided to the POS terminal 14a. Thereafter, the server apparatus 12 terminates the processing.

Further, in the description of the flowchart in FIG. 8, it is stated that the customer brings the empty bag of the commodity 20 to the store, however, as soon as the commodity 20 is purchased at the store, the flowchart illustrated in FIG. 8 can be executed, whereby when the condition for receiving the service to be provided is satisfied, the service to be provided can be also immediately received.

Further, in ACT 48, the service provision instruction unit 50d transmits the information indicating that there is no service to be provided to the POS terminal 14a, however, at this time, a condition insufficient for receiving the service may be simultaneously transmitted thereto. Then, the POS terminal 14a may inform the customer of the condition insufficient for receiving the service.

As described above, in the server apparatus 12 (the sales promotion support apparatus) of the embodiment, the service provision determination unit 50c (the determination unit) determines whether or not to provide the predetermined service, based upon the code information for uniquely specifying the commodity 20 which is attached to the commodity 20 purchased by the customer and is acquired by the individual commodity code acquisition unit 50a (the acquisition unit) and the sales history including the code information and the sales date and time stored in the sales history storage unit 50b (the storage unit). Then, the service provision instruction unit 50d (the provision unit) allows the customer to be provided with the predetermined service based upon the determination result of the service provision determination unit 50c. Accordingly, the service can be provided even to a customer who does not have a customer ID.

Further, in the server apparatus 12 (the sales promotion support apparatus) of the embodiment, the service provision determination unit 50c (the determination unit) determines whether or not the predetermined commodity 20 is purchased at the frequency exceeding the predetermined threshold value within the predetermined period. Accordingly, the sales promotion can be achieved by providing the service based upon the sales frequency of the predetermined commodity 20.

Further, in the server apparatus 12 (the sales promotion support apparatus) of the embodiment, the service provision determination unit 50c (the determination unit) determines whether or not there exists the simultaneously purchased commodity purchased simultaneously with the specified commodity 20 at the frequency exceeding the predetermined threshold value. Accordingly, the sales promotion can be achieved by providing the service based upon the sales frequency of the simultaneously purchased commodity.

Further, in the server apparatus 12 (the sales promotion support apparatus) of the embodiment, the sales history storage unit 50b (the storage unit) stores the sales history including the code information of the commodity 20 sold in the plurality of stores set in advance and the sales date and time in association with each other, and the service provision determination unit 50c (the determination unit) determines whether or not to provide the predetermined service based upon the code information attached to the commodity 20 purchased by the customer and the sales history of the commodity 20 in the plurality of stores. Therefore, the sales promotion can be achieved by providing the service by adding up the purchase result in the plurality of stores set in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sales promotion support apparatus, comprising:
an acquisition component for acquiring code information that is attached to a commodity sold to a customer and uniquely specifies the commodity;
a storage component for storing a sales history including the code information acquired by the acquisition component and a sales date and time of the commodity;
a determination component for determining whether or not to provide a predetermined service based upon code information attached to a commodity purchased by a customer and a storage content of the storage component; and
a provision component for providing the predetermined service based upon a determination result of the determination component.

2. The apparatus according to claim 1, wherein
the determination component determines whether or not a predetermined commodity is purchased at a frequency exceeding a predetermined threshold value within a predetermined period.

3. The apparatus according to claim 1, wherein
the determination component determines whether or not there exists a simultaneously purchased commodity purchased simultaneously with a specific commodity at a frequency exceeding a predetermined threshold value.

4. The apparatus according to claim 1, wherein
the storage component stores a sales history including code information of a commodity sold in a plurality of stores set in advance and a sales date and time thereof in association with each other, and
the determination component determines whether or not to provide the predetermined service based upon the code information attached to the commodity purchased by the customer and the sales history of the commodity in the plurality of stores.

5. The apparatus according to claim 1, wherein
the acquisition component comprises an RFID reader.

6. A sales promotion support system, comprising:
a terminal apparatus including an acquisition component for acquiring code information that is attached to a commodity sold to a customer and uniquely specifies the commodity, and a provision component for providing a predetermined service based upon code information attached to a commodity purchased by a customer, the code information acquired by the acquisition component, and a sales date and time of the commodity; and
a server including a storage component for storing a sales history including the code information acquired by the acquisition component and the sales date and time of the commodity, and a determination means for determining whether or not to provide the predetermined service based upon the code information attached to the commodity purchased by the customer and a storage content of the storage component.

7. The system according to claim 6, wherein
the determination component determines whether or not a predetermined commodity is purchased at a frequency exceeding a predetermined threshold value within a predetermined period.

8. The system according to claim 6, wherein
the determination component determines whether or not there exists a simultaneously purchased commodity purchased simultaneously with a specific commodity at a frequency exceeding a predetermined threshold value.

9. The system according to claim 6, wherein
the storage component stores a sales history including code information of a commodity sold in a plurality of stores set in advance and a sales date and time thereof in association with each other, and
the determination component determines whether or not to provide the predetermined service based upon the code information attached to the commodity purchased by the customer and the sales history of the commodity in the plurality of stores.

10. The system according to claim 6, wherein
the acquisition component comprises an RFID reader.

11. The system according to claim 6, wherein
the code information is comprised in a tag attached to the commodity sold.

12. The system according to claim 6, wherein
the code information is comprised in an RFID tag attached to the commodity sold.

13. The system according to claim 6, wherein
the terminal apparatus is a POS terminal.

14. The system according to claim 13, comprising a plurality of POS terminals.

15. A method for causing a computer controlling a sales promotion support apparatus to perform the following acts:
acquiring code information that is attached to a commodity sold to a customer and uniquely specifies the commodity;
storing a sales history including the code information acquired by the acquisition means and a sales date and time of the commodity;
determining whether or not to provide a predetermined service based upon code information attached to a commodity purchased by a customer and a storage content of the sales history; and
providing the predetermined service based upon a determination result of the determining act.

16. The method according to claim 15, the sales promotion support apparatus further performing the following acts:
determining whether or not a predetermined commodity is purchased at a frequency exceeding a predetermined threshold value within a predetermined period.

17. The method according to claim 15, the sales promotion support apparatus further performing the following acts:
determining whether or not there exists a simultaneously purchased commodity purchased simultaneously with a specific commodity at a frequency exceeding a predetermined threshold value.

18. The method according to claim 15, the sales promotion support apparatus further performing the following acts:
storing a sales history including code information of a commodity sold in a plurality of stores set in advance and a sales date and time thereof in association with each other, and
determining whether or not to provide the predetermined service based upon the code information attached to the commodity purchased by the customer and the sales history of the commodity in the plurality of stores.

19. The method according to claim 15, the sales promotion support apparatus further performing the following acts:
acquiring code information from a tag attached to the commodity sold.

20. The method according to claim 15, the sales promotion support apparatus further performing the following acts:
acquiring code information from an RFID tag attached to the commodity sold.
